(19) United States
(12) Patent Application Publication
(10) Pub. No.: US 2010/0122253 A1
(43) Pub. Date: May 13, 2010

(54) SYSTEM, METHOD AND COMPUTER PROGRAM PRODUCT FOR PROGRAMMING A CONCURRENT SOFTWARE APPLICATION

(76) Inventor: Perry Benjamin McCart, Bonner, MT (US)

Correspondence Address: Perry Benjamin McCart, P.O. Box 2848, Missoula, MT, 59806, US

(21) Appl. No.: 12/614,467

(22) Filed: Nov. 9, 2009

Related U.S. Application Data
(60) Provisional application No. 61/112,770, filed on Nov. 9, 2008.

(51) Int. Cl. G06F 9/46

(52) U.S. Cl. 718/100

(57) ABSTRACT

A system, method and computer program product for programming a concurrent software application includes a plurality of shared resources. An ordered list of the shared resources is used by each thread of the application for maintaining a strict total ordering of the shared resources, where each of the shared resources includes a unique identifier. A plurality of mutexes enables a thread to acquire exclusive access to the shared resources. A mutex lock list is associated with a shared resource for maintaining a list of mutex locks acquired during access of the shared resource by the thread. The list is comprised of the mutex associated with the shared resource and all mutexes of shared resources preceding the shared resource in the ordered list, wherein each of the mutex locks has been acquired in an order corresponding to the strict total ordering of the shared resources.

### CROSS- REFERENCE TO RELATED APPLICATIONS

The present Utility patent application claims priority benefit of the U.S. provisional application for patent Ser. No. 61/112,770 filed Nov. 9, 2008 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO A SEQUENCE LISTING, A TABLE, OR A COMPUTER PROGRAM LISTING APPENDIX

A computer program comprising multiple ASCII formatted files accompanies this application and is incorporated by reference. The computer program listing appendix includes the following files:

| | | |
|---|---|---|
| auto_vector.txt | 2,960 bytes | created 09/18/2008 |
| id_generator.txt | 1,543 bytes | created 09/18/2008 |
| lock_assigner.txt | 1,306 bytes | created 09/18/2008 |
| lock_broker.txt | 5,006 bytes | created 09/18/2008 |
| locked_data.txt | 1,768 bytes | created 09/18/2008 |
| mutex_recursive_wrapper.txt | 2,182 bytes | created 09/18/2008 |
| scoped_lock.txt | 1,264 bytes | created 09/18/2008 |
| shared_data.txt | 4,326 bytes | created 09/18/2008 |

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to multi-threaded computer programming. More particularly, the invention relates to a generalized solution for preventing deadlock in multi-threaded programs.

### BACKGROUND OF THE INVENTION

From the 1970s until after the turn of the century, processors have followed the pattern of Moore's Law. Moore's Law states that the number of transistors on a chip will double about every two years. Accompanying the increase in transistor count and density on a processor from at least the 1980s until after the turn of the century has been an associated increase in processor clock speed. During that time period, processor clock speeds have increased exponentially, doubling from approximately every two and a half years during the 1980s to doubling every year and a half during the 1990s. Processors produced by the major manufacturers over the past few years have not kept up with expected performance gains in processor speeds even though Moore's Law has held true regarding transistor counts. This has resulted in the hardware industry making a shift in direction from producing processors with higher clock speeds to producing multiple processor cores on a single chip. This approach has allowed them to continue to dramatically increase the overall computing power on their chips from year to year. Unfortunately, this has negatively affected the software industry over the past few years.

Over the past thirty years, the software industry has relied upon increases in processing speeds to improve the performance of software. This has allowed the industry to continually increase software complexity and performance without having to do any special optimization of the software design, or limit functionality. There are major factors that affect processing speeds, including processor clock speeds, execution optimization, and cache. The most significant of these factors in the continued increase of software performance has been the exponential increase of processor clock speeds. However the past few years has brought only a modest increase in processor speeds. In short the exponential increase of processor clock speeds has ended. This is resulting in the software industry making a paradigmatic shift towards concurrency, the solution for continuing performance. It is necessary for software to be concurrent for it to continue to take advantage of the increasing processing power of new hardware. That means writing multi-threaded programs. However, writing multi-threaded programs is difficult, to say the least.

Writing concurrent software in general and multi-threaded software in particular is difficult. The difficulty arises from the necessity of sharing resources among threads. The problems of sharing resources in multi-threaded programming can be summarized as three main problems: race conditions, deadlock, and starvation. A race condition is a scenario in which one thread modifies a resource without consideration for synchronizing the modification of the resource with other threads that may access it, resulting in the resource state becoming corrupted. Deadlock is a scenario in which two or more threads are competing over the same resources to the mutual exclusion of each other, each preventing the other from acquiring the resources it needs to continue operation. Starvation is where a thread can never get access to all the resources it needs to complete its operation, because at least one of the resources are in use at any given time by one or more other threads. The race condition problem has been solved with the mutex-lock paradigm, which has become an industry standard solution.

Today, there is no industry standard solution for the other two multi-threading problems of deadlock and starvation. This is a serious problem in the industry because deadlock and starvation are nondeterministic and therefore not consistently reproducible. The traditional approach of testing software to ensure its quality is not sufficient. Just because a multi-threaded program passes unit tests does not mean that there is not an inherent flaw in the program's logic. A multi-threaded program may perform correctly for years and then suddenly quit working altogether. Correct behavior in a multi-threaded program is no guarantee of program correctness or correct behavior in the future. What programmers need is an industry standard solution to the problems of deadlock and starvation on par with the mutex-lock paradigm.

Some significant improvements have been made in the field of the invention by developing new tools that help locate logic errors in software that could result in deadlock or starvation. However, contributions towards a general solution to deadlock and starvation have been slow. A commonly known practice for avoiding deadlock in multi-threaded programming is to lock shared resources in the same order among all threads that use those resources. In practice, this approach is one that the programmer has been responsible for carefully implementing in their code, which is prone to incorrect implementation, still resulting in deadlock.

A partial solution known as lock hierarchies has been devised that uses an ordered locking approach to prevent deadlock. A lock hierarchy is the logical leveling of all shared resources based on arbitrary priority. The principal idea underlying lock hierarchies is to assign a lock level for each shared resource, and to use the lock level to dictate the order in which locks may be acquired. In this approach locks can only be acquired in descending levels, therefore no lock may be acquired on a higher leveled shared resource than the current lowest level lock that is held. The idea is to prevent cycles between levels where locks are acquired. In the lock hierarchy model, preventing cycles is equivalent to preventing deadlock. In practice, lock levels are typically assigned based on application layers. For example, the highest lock levels would correspond to the graphical user interface layer, the middle lock levels would correspond to the middle layers such as database application programming interfaces (APIs), and the lowest lock levels would correspond to the services supplied by operating system level calls. With this scenario, if a lock was held on a shared resource at the database logic level, a lock could not be acquired on a shared resources at the higher graphical user interface level, but a lock could be acquired on a shared resource at the lower basic services level.

Some work has recently been done in adapting the typical lock hierarchy concept from facilitating concurrency among a limited number of threads running logic for different layers of an application to facilitating generic concurrency for any number of threads for the purpose of doing work faster. In one implementation, an adaption of lock hierarchies has been made to automate the acquisition of multiple locks at the same logical level. This is done by using the memory address of each lock as a unique identifier. By acquiring the locks at one time as a group, the memory address of locks may be used to order the acquisition of locks. As with other implementations, the lowest level for a currently acquired lock is maintained for each thread. If an acquisition is attempted on a lock with an equal or higher level, an exception is thrown, preventing potential deadlock. However, this implementation still has certain limitations inherent in lock hierarchies.

Lock hierarchies have two general limitations. The first general limitation of lock hierarchies is that they are not composable. Consider the case where a resource is shared with an external module. Since the lock levels assigned by programmers are arbitrary, there is no way for the programmers of the external module to devise a lock level scheme for shared resources that will be compatible in every case with the lock levels arbitrarily assigned by the programmers that use that module. Even if the required lock level range to be used for the module is well documented and enforced by the module, there is no guarantee that the range of levels will be compatible with the existing programs that may want to use the module. For example, if a graphics library module was designed to use lock levels 5000-5999, the level range will be incompatible with an existing program that already has lock levels 5000-5999 assigned for database API calls. Even if the programmers are willing, refactoring lock levels may not be an option if another external module the program depends on uses conflicting lock levels. In the previous example this could be an external module for handling database logic that uses lock levels 5400-5499.

Arbitrary assignment of lock levels is not the only composability problem that lock hierarchies have. Lock hierarchies also suffer from inability to compose functionality when taking multiple locks at the same level. This is because lock hierarchies adapted for taking multiple locks at the same level require that the locks all be acquired at the same time. They do this so they can enforce taking the locks in a prescribed manner to prevent deadlock. Their method does not span separate calls to take multiple locks for the same level, and therefore deadlock may occur if multiple locks at the same level are allowed to be acquired at two separate times or in two separate places. Therefore it is not possible to compose separate functions that take locks on shared resources of the same level into the same thread. The locks of the same level used by both functions must be acquired in one location all at the same time and passed to the functions that use them. If this is not done and one function takes multiple locks and then calls another function that takes multiple locks of the same level, the lock hierarchy will be violated since the locks being taking are not at a lower level than all the locks that are currently held. If restrictions on the hierarchy are relaxed so that locks can be acquired at the same level as currently held locks then the possibility of deadlock is introduced, since the locks may be acquired in an order other than prescribed.

The composability problem of lock hierarchies is most glaring when third party modules are used in a program. The problem can be worked around to some degree in code the programmer controls. There can be no workarounds in code that the programmer does not control or in unknown code. There is a real problem when calling unknown code while holding locks, because it is not known whether or not a lock will be attempted in the unknown code. If a lock is attempted at an equal or higher level than the lowest level lock currently held then the lock hierarchy is violated and the best that can be hoped for is an exception. Unknown code is not limited to third party modules. Virtual functions also need to be treated as unknown code, because there is no guarantee that another programmer working on the code at a later date will not add another derived class that will lock shared resources. This effectively means that in lock hierarchies virtual functions cannot safely be called while holding a lock, which is an undesirable limitation.

The second general limitation of lock hierarchies, and typical of locks, is that programmers are required to maintain the implicit relationship between locks and the shared resources those locks protect. Examples include when a lock for a shared resource is not acquired before using that shared resource, or when a lock is not released after a thread is done using a shared resource. The later example results in the starvation of other threads that use the shared resource, since they cannot get a lock on the resource until the existing lock is released. This problem was easily solved with the advent of object-oriented technology. The solution was to encapsulate locking with an object. That way the lifetime of a lock for a shared resource is tied to the lifetime of an object. In this way a lock object created for a shared resource within a given scope of the program automatically releases a lock in its destructor at the close of the given scope. Locks that use this object-oriented technique are often referred to as scoped locks. The first example results in race conditions, since a lock is not held when using the associated shared resource. Although less frequent than other problems such as deadlock, race conditions are still possible when the implicit relationship between a shared resource and associated lock is accidentally not preserved by the programmer.

In light of these limitations, programmers need a better solution to the problems of deadlock, starvation, and accidental race conditions. The nature of the problem with existing partial solutions is that there are still many requirements on the programmer, who must carefully implement concurrency in software to ensure program correctness. Any solution will address the nature of the problem by removing the requirements from the programmer. The programmer should not need to know the workings of a specific implementation or take any special care in the design of concurrent software to maintain program correctness.

Specifically, the issues of composability, exceptions, arbitrary classification, and holding locks while calling unknown code all need to be addressed. Programmers should not need to worry about correctly classifying locks in a hierarchy to maintain program correctness, including the cases of interaction between a program's lock hierarchy in relation to other third party modules. Programmers need the freedom to take any number of locks for shared resources in multiple places and at multiple times as desired. Also, the desired solution will not throw exceptions as a means to avoid potential deadlock when locks are requested out of order. Throwing an exception is not a real solution to deadlock, it is simply a tool to help debug deadlock. Holding a lock and calling unknown code also needs to be safe. An additional benefit for programmers would be to remove the necessity of manually maintaining implicit relationships between locks and the shared resources that they protect so that accidental race conditions may not occur.

In view of the foregoing, there is a need for improved techniques for providing a method for preventing deadlock, starvation and accidental race conditions that does not require the programmer to consider the classification of locks in the hierarchy or to worry about maintaining correctness with concurrent software.

### SUMMARY OF THE INVENTION

To achieve the forgoing and other objects and in accordance with the purpose of the invention, a system, method and computer program product for programming a concurrent software application is presented.

In one embodiment a system for programming a concurrent software application is presented. The system includes a plurality of shared resources, means for maintaining a strict total ordering of the shared resources, means for enabling a thread to acquire exclusive access to the shared resources and means for maintaining a list of locks acquired during access of a shared resource by the thread, wherein each of the locks has been acquired in an order corresponding to the strict total ordering of the shared resources. In another embodiment each of the enabling means enables the thread to acquire the exclusive access a plurality of times. In yet another embodiment the shared resources and the lock list are encapsulated as object classes. Still another embodiment further includes means for generating a unique identifier for each of the shared resources that is increasing according to the strict total ordering.

In another embodiment a method for programming a concurrent software application is presented. The method includes steps for registering a shared resource for a thread of the application, where the shared resource is uniquely identified, steps for requesting a lock on the shared resource for exclusive access to the shared resource by the thread, steps for identifying all shared resources to be locked with the shared resource, steps for acquiring locks on the identified shared resources and the shared resource, steps for assigning a lock list of acquired locks to the shared resource, steps for performing an operation on the shared resource, steps for releasing the acquired locks upon completion of the operation, steps for repeating the steps for requesting, identifying, acquiring, assigning, performing and releasing until the thread has completed performing operations on the shared resource and steps for unregistering the shared resource. Another embodiment further includes steps for creating a shared resource for a thread of the application. Yet another embodiment further includes steps for aborting the thread upon determination that registering the shared resource results in an inconsistent ordering. Still another embodiment further includes steps for aborting the thread upon determination of a failure of registering the shared resource. Another embodiment further includes steps for encapsulating the shared resource and the lock list as object classes. Yet another embodiment further includes steps for generating unique identifiers associated with the shared resources that is increasing.

In another embodiment a system for programming a concurrent software application is presented. The system includes a plurality of shared resources. An ordered list of the shared resources is used by each thread of the application for maintaining a strict total ordering of the shared resources, where each of the shared resources includes a unique identifier. A plurality of mutexes, each of the mutexes being associated with a one of the shared resources, enables a thread to acquire exclusive access to the associated one of the shared resources. A mutex lock list is associated with a shared resource for maintaining a list of mutex locks acquired during access of the shared resource by the thread. The list is comprised of the mutex associated with the shared resource and all mutexes of shared resources preceding the shared resource in the ordered list, wherein each of the mutex locks has been acquired in an order corresponding to the strict total ordering of the shared resources. In another embodiment each of the mutexes enables the thread to acquire the exclusive access a plurality of times. In yet another embodiment the mutex locks are released after the access. In still another embodiment the mutex lock list is populated prior to the access. In another embodiment the shared resources and the mutex lock list are encapsulated as object classes. In another embodiment the unique identifier is generated to be strictly increasing.

In another embodiment a method for programming a concurrent software application is presented. The method includes steps of registering a shared resource for a thread of the application, where the shared resource is uniquely identified in an ordered list of shared resources. The method includes steps of requesting a lock on the shared resource for exclusive access to the shared resource by the thread and identifying all shared resources in the ordered list, ordered before the shared resource, to be locked with the shared resource. The method includes steps of acquiring locks on mutexes associated with the identified shared resources and the shared resource in an order of placement in the ordered list and assigning a mutex lock list of acquired mutex locks to the shared resource. The method includes steps of performing an operation on the shared resource and releasing the acquired mutex locks upon completion of the operation. The method includes steps of repeating the steps of requesting, identifying, acquiring, assigning, performing and releasing until the thread has completed performing operations on the shared resource. The method includes steps of unregistering the shared resource upon completion of operations on the shared resource by the thread. Another embodiment further includes the step of creating a shared resource for a thread of the application. In yet another embodiment the step of unregistering further includes removing the shared resource from the ordered list. Still another embodiment further includes the step of aborting the thread upon determination that registering the shared resource results in an inconsistent ordering of shared resources among threads in the application. Another embodiment further includes the step of aborting the thread upon determination that the shared resource, for which a lock has been requested, is absent from the ordered list. Yet another embodiment further includes the step of encapsulating the shared resource and the mutex lock list as object classes. Still another embodiment further includes the step of generating unique identifiers associated with the shared resources where the created shared resource has a unique identifier with higher logical ordering than previously registered shared resources.

In another embodiment a computer program product for programming a concurrent software application is presented. The computer program product includes computer program code for registering a shared resource for a thread of the application, where the shared resource is uniquely identified in an ordered list of shared resources. Computer program code requests a lock on the shared resource for exclusive access to the shared resource by the thread. Computer program code identifies all shared resources in the ordered list, ordered before the shared resource, to be locked with the shared resource. Computer program code acquires locks on mutexes associated with the identified shared resources and the shared resource in an order of placement in the ordered list. Computer program code assigns a mutex lock list of acquired mutex locks to the shared resource. Computer program code performs an operation on the shared resource. Computer program code releases the acquired mutex locks upon completion of the operation. Computer program code repeats the steps of requesting, identifying, acquiring, assigning, performing and releasing until the thread has completed performing operations on the shared resource. Computer program code unregisters the shared resource upon completion of operations on the shared resource by the thread. A computer-readable media stores the computer program code. Another embodiment further includes computer program code for creating a shared resource for a thread of the application. In yet another embodiment the computer program code for unregistering further includes computer program code for removing the shared resource from the ordered list. Still another embodiment further includes computer program code for aborting the thread upon determination that registering the shared resource results in an inconsistent ordering of shared resources among threads in the application. Another embodiment further includes computer program code for aborting the thread upon determination that the shared resource, for which a lock has been requested, is absent from the ordered list. Yet another embodiment further includes computer program code for encapsulating the shared resource and the mutex lock list as object classes. Still another embodiment further includes computer program code for generating unique identifiers associated with the shared resources where the created shared resource has a higher logical ordering unique identifier than previously registered shared resources.

Other features, advantages, and object of the present invention will become more apparent and be more readily understood from the following detailed description, which should be read in conjunction with the accompanying drawings.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a component block diagram illustrating the main elements of an exemplary composable deadlock solution, in accordance with an embodiment of the present invention;

FIG. 2 is a flowchart illustrating the detailed control flow for an exemplary method for locking shared resources with multiple threads, in accordance with an embodiment of the present invention;

FIG. 3 is a unified modeling language (UML) class diagram illustrating exemplary classes for a composable deadlock solution using object oriented programming, in accordance with an embodiment of the present invention;

FIG. 4 is a UML sequence diagram illustrating an exemplary method for locking shared resources with multiple threads using object oriented programming, in accordance with an embodiment of the present invention; and

FIG. 5 illustrates a typical computer system that, when appropriately configured or designed, can serve as a computer system in which the invention may be embodied.

Unless otherwise indicated illustrations in the figures are not necessarily drawn to scale.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

A purpose of preferred embodiments of the present invention is to address the limitations of previous solutions by providing software developers with a generalized solution to preventing deadlock, and to do so in a way which is neither cumbersome, nor adds significant overhead. Preferred embodiments of the present invention accomplish this purpose by ensuring that locks are always acquired on shared resources in the same order between different threads, when they are acquired by the use of a solution according to preferred embodiments of the present invention. The method utilized by preferred embodiments of the present invention to do this is to define a strict total ordering among all shared resources and to track all shared resources used within each thread. When a lock is requested on a specific resource shared with a thread, the solution according to preferred embodiments of the present invention acquires locks on all resources shared with the thread that are ordered before the specified shared resource. This is done in order, until a lock is acquired on the requested shared resource. All the acquired locks are then returned to the control of the programmer as a logical group for the duration of time that the requested shared resource is accessed. Employing this method, programmers can use preferred embodiments of the present invention to lock as many shared resources, as many times, and from as many places in any given thread as they desire without any need for considering locking order, since the selection of which locks to be acquired and the order in which they are acquired is controlled by a solution according to preferred embodiments of the present invention.

An advantage of preferred embodiments of the present invention over previous solutions that prevent deadlock among multiple threads is that preferred embodiments of the present invention provide a generalized solution that is composable. In the field of concurrency, composability is the ability to combine modules with a software system, where any module, including third party modules, can be incorporated into the system without the possibility of conflicts arising in the utilization of shared resources. Because they are composable, preferred embodiments of the present invention provide safety in scenarios where unknown code is called while holding a lock, as long as all unknown code utilizes the present invention for access to shared resources. All classification of lock order is handled by a solution according to preferred embodiments of the present invention, freeing the programmer from this tedious task. Also, preferred embodiments of the present invention will not exhibit inconsistent exception throwing behavior in relation to preventing deadlock.

A desirable characteristic of preferred embodiments of the present invention is that they do not lend themselves to starvation. More specifically, threads that utilize solutions according to preferred embodiments of the present invention generally will not starve as a result of waiting to acquire locks on shared resources when the following four conditions are met. The first condition is that attempts by a thread to acquire a lock on a shared resource that is already in use result in blocking further execution of the thread until the lock is acquired. The second condition is that all locking attempts on a shared resource already locked by another thread are stored in a first in first out (FIFO) queue, where the next thread to be allowed to acquire a lock when it is released by the owning thread is the next thread waiting in the queue. The third condition is that threads are programmed in such a way that they do not maintain locks on shared resources indefinitely, that is outside the scope in which the shared resource is used. The fourth condition is that all threads utilizing preferred embodiments of the present invention have equal priority.

Preferred embodiments of the present invention provide software developers with a convenient way of writing concurrent software that is composable and free of deadlock. These are especially desirable qualities for companies that produce software products that utilize concurrency, since they represent considerable financial savings in a software product's development and support life cycle. This provides great incentive for protection of preferred embodiments of the current invention since the number of companies that develop concurrent software is growing drastically as the software industry makes a fundamental shift towards concurrency.

The environment of preferred embodiments of the present invention is typically a single computer operating system process in which a multiplicity of threads shares a multiplicity of resources. Preferred embodiments of the present invention are utilized by programmers during the software development process to automate the management of acquiring locks on resources shared among multiple threads at run time.

In this application the intended meaning of each of the following terms is specified as follows. A recursive mutex is a mutual exclusion object that may be locked recursively by a single thread once that thread acquires a first lock on the mutex. A scoped lock is a lock that is acquired for a specific scope of the program execution, after completion of which the lock is automatically released. Implementation of scoped locks is typically accomplished through object lifetimes using object oriented techniques. Thread local storage (TLS) is a variable that has exactly one unique visible state for every thread. FIFO is a very common queuing algorithm for scheduling in which the first item to enter the back of the line for the queue is the first item out the front of the line for the queue. A blocking lock is a lock that acquires exclusive access to a shared resource; all other threads that access the resource will be blocked from further execution until they acquire exclusive access to the resource in their turn.

At an abstract level a basic embodiment of the present invention is comprised of resources shared between threads, and a list of shared resources used by each thread. Locks are always acquired for shared resources in the same order; this is accomplished by establishing a strict total ordering for all shared resources. To establish a strict total ordering among all shared resources, each shared resource is associated with a unique identifier which may be ordered according to an arbitrary sort order.

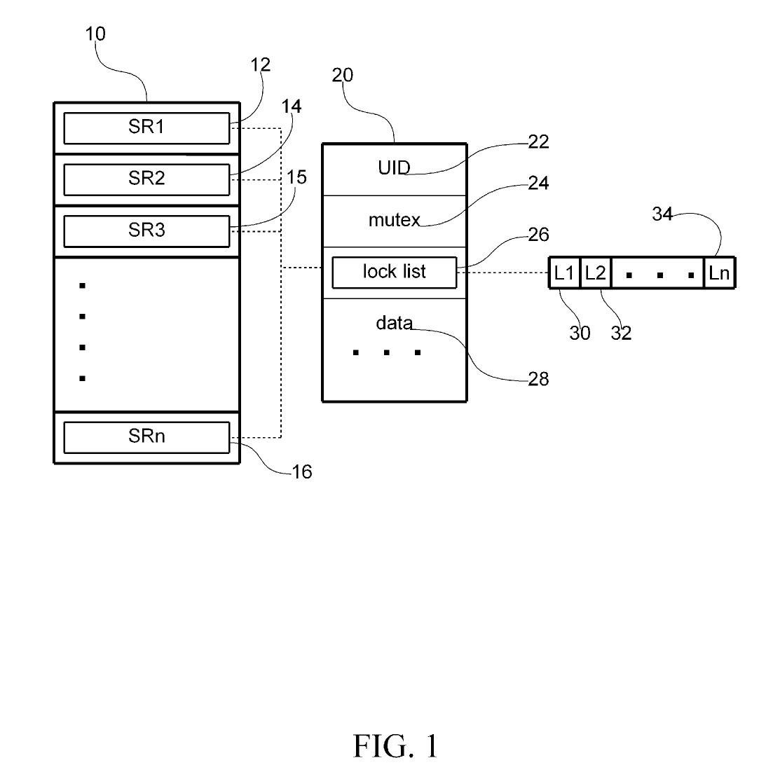

FIG. 1 is a component block diagram illustrating the main elements of an exemplary composable deadlock solution, in accordance with an embodiment of the present invention. In the present embodiment, all shared resources 20 are logically made up of data 28, a recursive mutex 24, a unique identifier (UID) 22, and a lock list 26 which is a logical grouping of one or more mutex locks Shared resource 20 is a structural diagram of all shared resources contained in list 10. A new lock list 26 is created by list 10 each time data 28 in a shared resource 20 is to be accessed. A shared resource's 20 lock list 26 will be empty when data 28 is not being accessed. Data 28 may be memory, such as, but not limited to, a variable, a handle, such as, but not limited to, a file or port, or some other type of input output (I/O) device, etcetera. Data 28 is essentially the token that represents or interfaces with the logical resource. As is currently known to those skilled in the art, a mutex is used to prevent race conditions on a shared resource. In the present invention, mutex 24 must be a recursive mutex so that the same thread may acquire locks on mutex 24 multiple times without incurring deadlock. Unique identifier 22 is used to uniquely identify shared resource 20 and, in this implementation, determine the order in which a group of shared resources are locked. Locking shared resources 20 in a consistent order is the means by which the present invention prevents deadlock from occurring.

For each thread a list 10 of resources shared with that thread is maintained by the present invention. In a non limiting scenario of the present embodiment list 10 comprises a first shared resource 12, a second shared resource 14, a third shared resource 15, and so on up to a last shared resource 16. Each of these shared resources comprises the same attributes as exemplary shared resource 20. Those skilled in the art, in light of the present teachings, will readily recognize that the lists of shared resources in the present embodiment, or alternate embodiments, may comprise any number of shared resources. In the present embodiment, list 10 enables all resources used in the thread to be locked in a consistent order, since list 10 establishes the ordering of the shared resources. In this implementation list 10 is ordered based on a unique identifier associated with each shared resource, for example, without limitation, unique identifier 22 in shared resource 20. However, in alternate embodiments the list may be ordered based on various different criteria such as, but not limited to, the non concurrent order in which shared resources are created, non concurrent order in which locks are first requested on a shared resource, a total ordering based on the partial ordering in which resources are shared with child threads, as long as created resources can only be shared with child threads, and not sibling or parent threads, etcetera. In the present embodiment, first shared resource 12 in list 10 is the shared resource that has a unique identifier 22 that comes first based on a strict total ordering. Last shared resource 16 in list 10 is the shared resource that has a unique identifier 22 that comes last based on a strict total ordering. Without list 10 and strict total ordering, it is not possible to establish what other shared resources need to first be locked, or the order in which they are to be locked, before a lock is attempted on a particular shared resource. Any type of identifier or method of generating the same may be used as long as each identifier is unique. Examples of identifiers and methods of generating identifiers include, without limitation, a process memory address for the shared resource, a universally unique identifier (UUID), or a whole number with some arbitrary start point on the number line such as zero, and incremented by a global counter every time a new unique identifier is requested, etcetera. Resource unique identifiers 22 only need to be unique within the context in which resources are shared, typically an operating system process. Further examples of contexts in which unique identifiers 22 may be unique include, without limitation, unique among all processes for the operating system, etcetera.

In the present embodiment, lock list 26 of logically grouped mutex locks may be maintained by shared resource 20 while mutex 24 is locked and data 28 is in use. Lock list 26 maintains locks for each mutex 24 of each shared resource in the thread's list 10 of shared resources from first shared resource 12 up to and including the shared resource, which is being locked. Each shared resource will have a different lock list. In a non-limiting example, suppose that the data for shared resource 12 and shared resource 15 was being accessed, but that the data for shared resource 14 was not being accessed. In this scenario shared resource 12 would have a lock list containing a single mutex lock on only shared resource 12 mutex, since it is the first shared resource in list 10. Shared resource 14 will have an empty lock. However, shared resource 15 will have three mutex locks in its lock list, one lock on shared resource 12 mutex, one lock on shared resource 14 mutex, and one lock on shared resource 15 mutex. Because shared resource 15 is the third shared resource in list 10, list 10 would first have acquired a lock on shared resource 12 mutex, and then acquired a lock on shared resource 14 mutex, and then acquire a lock on shared resource 15 mutex to populate shared resource 15 lock list. This necessitates that mutex 24 of shared resource 20 is a recursive mutex, allowing a thread to acquire multiple locks without incurring deadlock. A first lock 30, L1 , of lock list 26 corresponds to first shared resource 12 of list 10. A second lock 32, L2, of lock list 26 corresponds to second shared resource 14 of list 10. A last lock 34, Ln, of lock list 26 corresponds to a shared resource being locked for use. A shared resource being locked for use may be at any position within list 10. Therefore lock list 26 may have only a single lock in it if the shared resource being locked is at the beginning of list 10, or may maintain a lock for every shared resource in list 10 if the shared resource being locked is at the end of the thread's list 10, such as shared resource 16. Note that the term “list” in reference to the thread's list, as in list 10 or a lock list of a shared resource is a generic term and may be implemented as any sort of a container such as, but not limited to, a linked-list, array, red-black tree, etcetera.

In the present embodiment, there are five main steps for using a resource shared with multiple threads. The first step is to create the shared resource. The second step is to register the resource with each thread which will use the shared resource. The third step is for a thread to lock the shared resource before it performs an operation on that resource. The fourth step is to unlock the shared resource after the thread is done with the operation performed on the shared resource. The fifth step is to unregister the shared resource from each thread when the thread is done using it.

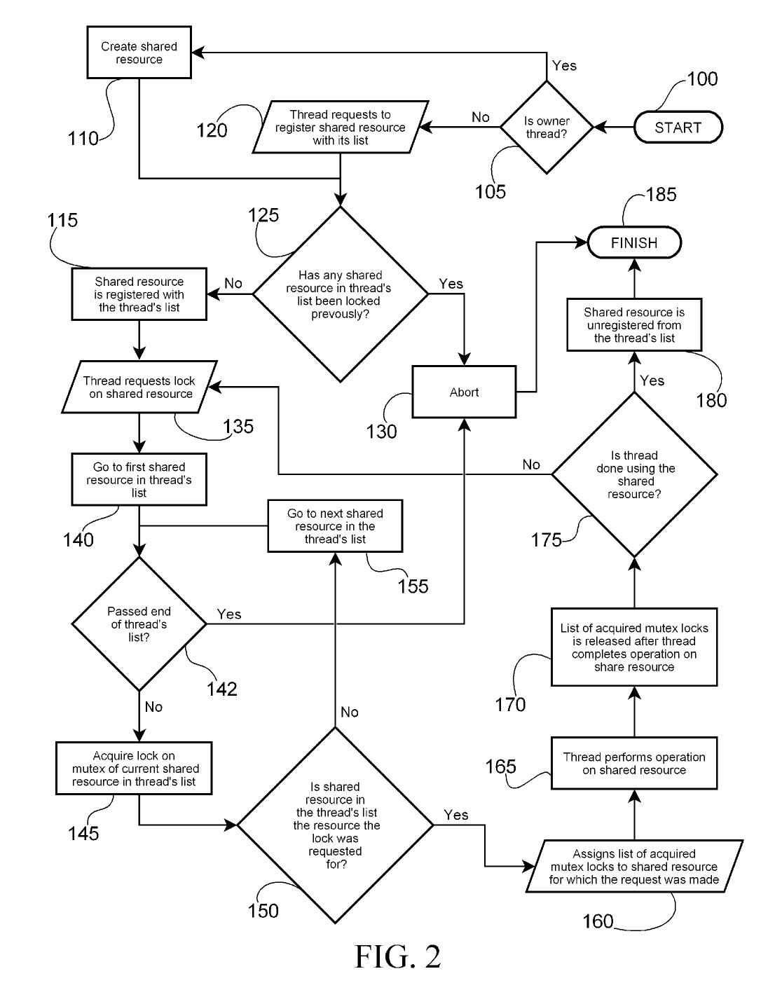

FIG. 2 is a flowchart illustrating the detailed control flow for an exemplary method for locking shared resources with multiple threads, in accordance with an embodiment of the present invention. In the present embodiment, the process starts at step 100. In step 105 it is determined if the thread is the owner thread. If the thread is the owner thread, it has control, as that is the thread in which the shared resource is created. The creation of the shared resource is accomplished in step 110. This is where the physical system resources representing the logical shared resource are actually initialized. In step 125 it is determined if any shared resource in the thread's list has been previously locked, such as, but not limited to, by using a flag, variable, or other similar mechanism to mark the event when it has occurred. If no shared resource in the thread's list has been previously locked, the shared resource is registered with the thread's list in step 115. However, if a shared resource in the thread's list has been locked previously by the thread, the thread aborts in step 130, which finishes the thread's process flow in step 185. Registration of the shared resource with the thread's list in step 115 is accomplished in practice by adding the shared resource to the thread's list of shared resources. The thread's list must be created and initialized at the point of registration if this has not been done previously. For threads other than the owner thread where the shared resource was created the control flow differs slightly for the registration step. If it is determined in step 105 that the thread with which a resource is shared is not the owner thread, then the thread requests to register the shared resource with the thread's list in step 120. If any shared resource registered with the thread's list has previously been locked by the thread as determined in step 125, the thread must abort in step 130, which finishes the thread's process flow in step 185. If no shared resource previously registered with the thread has been locked by the thread as determined in step 125, the shared resource is registered with the thread in step 115 by being added to the thread's list of shared resources. Failure of registration in step 125 after a lock has been acquired is necessary to ensure that locks are always acquired in a consistent order among threads to avoid deadlock. In a non-limiting example, suppose two shared resources A and B; A having a total ordering previous to B. If a thread was allowed to register shared resource A, after registering and acquiring a lock on shared resource B, then the thread is being allowed to lock the shared resources in the order in which they are registered with the thread's list, rather than according to the defined strict total ordering. Another thread could register and lock the shared resources in the opposite order, resulting in the potential for deadlock.

In the present embodiment in step 135, a thread requests a lock on a shared resource. The thread's list goes to the first shared resource in the thread's list in step 140 according to the strict total ordering of shared resources. In step 142 it is determined if the end of the thread's list is passed when attempting to go to the first or next shared resource in the thread's list. If so, the thread must abort in step 130, finishing the thread's process flow in step 185. Otherwise, a lock is acquired on the shared resource's mutex in step 145. In step 150 it is determined if the shared resource in the thread's list is the shared resource for which a lock was requested in step 135. If the shared resource in the thread's list is not the shared resource for which a lock was requested in step 135, the lock acquisition process is repeated by going to the next shared resource in the thread's list in step 155 according to the strict total ordering of shared resources. If the shared resource in the thread's list is the shared resource for which a lock was requested in step 135, then in step 160 the list of one or more acquired mutex locks is assigned to the shared resource for which the request was made. Please note that according to the above process, whenever a lock is requested in step 135 on a shared resource that has not been registered in the thread's list, it will result in the process being aborted in step 130.

After the thread performs the operation on the shared resource in step 165, step 170 is performed. In step 170 the shared resource's list of acquired mutex locks is released after the thread completes its operation on the shared resource. In step 175 it is determined if the thread is done using the shared resource. If the thread is not done using the shared resource, the process flow returns to step 135 to again request a lock on the shared resource. If the thread is done using the shared resource, step 180 occurs. In step 180 the shared resource is unregistered from the thread's list. This is accomplished in practice by removing the shared resource from the thread's list of shared resources. The process flow is then finished in step 185.

In summary, a basic embodiment of the present invention comprises the thread's list of shared resources, the recursive blocking mutex, and the unique identifier associated with each resource. In addition there must be a strict total ordering defined for shared resources. Locks must be acquired for shared resources according to this strict total ordering starting at first shared resource in the list up to and including the shared resource for which the lock was requested. The multiplicity of locks returned from a single lock request must be grouped together as a logical unit for the duration in which the shared resource is used and released as a logical unit afterward.

To generally ensure the proper working of a basic embodiment of the present invention, there are three rules that must be observed in its implementation. The first rule is that a shared resource must be registered in a thread before it can be locked in that thread. The second rule is that shared resources may not be registered in a thread at any time after another resource shared with that thread has been locked by that thread. The third rule is that shared resources may not be created in a thread and registered after any shared resource has been locked in that thread. The consequence of these rules is that all shared resources that may be needed by a thread must be created before any locks have been acquired on shared resources in the thread.

In an alternate embodiment of the present invention object oriented programming concepts are used to encapsulate the main elements of the solution. Some objectives of this embodiment are to protect against accidental misuse of the solution and to relax the restrictions regulating when a new shared resource can be created in a thread. One example of accidental misuse would be where a programmer forgets to insert code to request a lock on a shared resource before performing operations on that shared resource's data. This would create a potential race condition where an operation on the shared resources data may result in that data being in an unexpected, or even undefined state. Another example of accidental misuse by a programmer would be where the programmer forgets to insert code to release a lock on a shared resource after operations are performed on the shared resource, resulting in starvation of other threads that need to use the same shared resource but are unable to acquire a lock. To achieve the first objective, object oriented techniques are used to limit the programmer's access to a shared resource to the interval of time in which a lock is acquired on the resource's associated mutex. Additionally, object oriented techniques are used to ensure that a shared resource is removed from the thread's list of shared resources when the scope in which the shared resource is operated on is exited by a thread.

To accomplish the objective of protecting against accidental misuse of the solution in this embodiment, the shared resource and the thread's list of shared resources are encapsulated as object classes. Techniques such as, but not limited to, operator overloading, custom constructors, reference semantics, and encapsulation ensure that locks are acquired before the programmer can access the shared resource's data, that locks will be automatically released when the scope in which the shared resource's data was accessed is exited by the thread, and that the programmer will not be granted direct access to the shared resource's mutex or locks acquired on that mutex. Object classes are also used for mutexes and locks as well as other data that is passed back and forth between the object classes for the shared resource and the thread's list of shared resources. The second objective is achieved by tracking locks that have been acquired until they are released for each thread. This makes it safe to register new shared resources in a thread after all mutex locks that were acquired in the thread have been released. It is safe because locks will not be acquired out of order for shared resources if registration of shared resources occurs while there are no locks acquired by the thread. The danger lies in registering shared resources in a thread while locks are acquired, since the logical order of the shared resource being registered may come before the logical order of the shared resource for which a lock is already acquired. Consequently, the third rule of implementation for the current invention may be relaxed to restrict creation of shared resources in a thread to merely the period of time in which the thread has no mutex locks acquired, rather than never having acquired a single mutex lock.

Two advantages of this embodiment over a basic embodiment are that it gives the programmer more flexibility with creating new shared resources and protects against race conditions. In this embodiment the programmer is no longer limited to creating shared resources when a thread is initialized. The programmer can create shared resources at any point in which no other shared resources have locks acquired. Because registration for the creating thread happens automatically when a shared resource is created, a shared resource may not be created while the creating thread has any locks acquired. This is practically anywhere outside of the scope of where a lock is acquired on another resource shared with the thread. This embodiment protects against the problem of race conditions by limiting access to shared resources in such a way that the programmer must acquire a mutex lock to have access to the resource. Additionally, with the use of scoped locks in the present embodiment, the programmer is freed from having to remember to manually program the release of mutex locks acquired for access to the shared resource. Another advantage of this embodiment is that it automatically takes care of the unregister step when a shared resource is released.

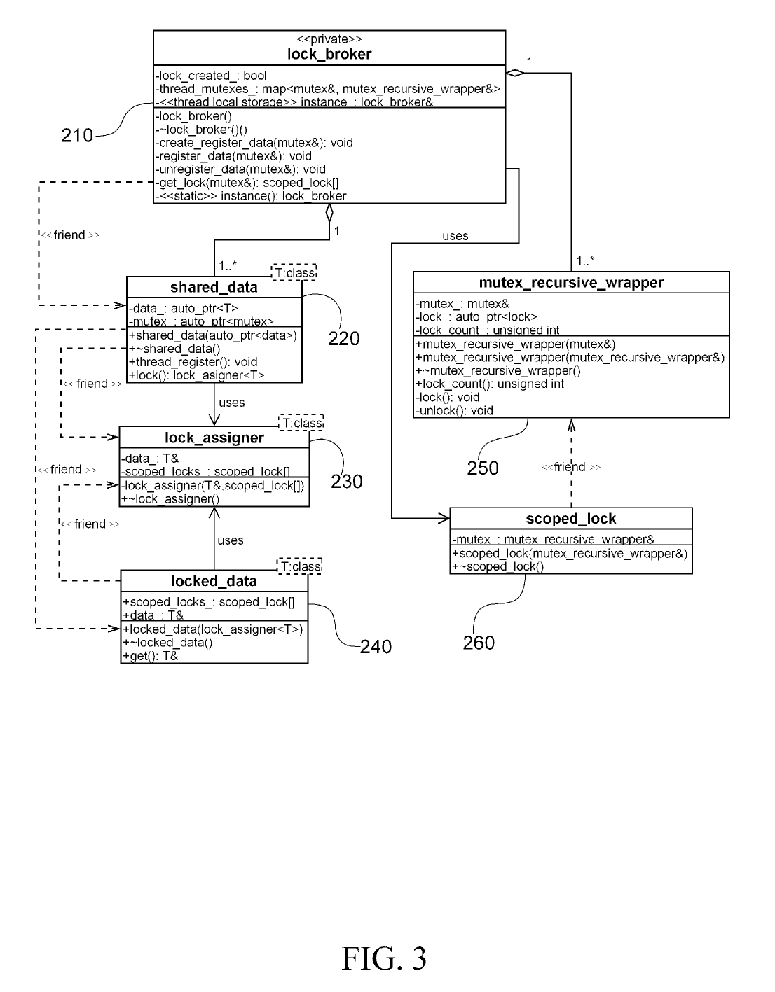

FIG. 3 is a unified modeling language (UML) class diagram illustrating exemplary classes for a composable deadlock solution using object oriented programming, in accordance with an embodiment of the present invention. There are six object classes used to implement the present embodiment; however, those skilled in the art, in light of the present teachings, will readily recognize that alternate embodiments may be implemented with more or fewer object classes. All object class attributes shown, by way of example, in FIG. 3 are named with a trailing underscore (i.e., data_) as a matter of convention, to distinguish them from the abstract constructs they represent when both are being described. In the present embodiment, three of the object classes are used to implement the main elements of the invention. These three are a lock_broker object class 210, a shared_data object class 220, and a locked_data object class 240. The three additional supporting object classes are a lock_assigner object class 230, a mutex_recursive_wrapper object class 250, and a scoped_lock object class 260.

Shared_data object class 220 is an encapsulation of an abstract shared resource's concrete data. All shared_data objects are non-copyable. The main elements encapsulated within shared_data object class 220 include, without limitation, a data_attribute and an associated mutex_attribute. In the present embodiment the mutex's logical memory address within the operating system process serves as the identifier for a shared_data object, so there is no need for an explicit identifier attribute. In the constructor of the shared_data object, it takes ownership of the data via the data_attribute value and instantiates a new mutex as the mutex_attribute to associate with the data for the lifetime of the object. The constructor also registers the shared_data object with a lock_broker object of the thread by passing it a reference to its mutex_attribute. A destructor releases the data_attribute and mutex_attribute values. The destructor also unregisters the shared_data object with the thread's lock_broker object by passing it a reference to its mutex_attribute. A thread_register method is used to register the shared_data object with the lock_broker object in a child thread. A lock method is used to acquire a lock on the mutex_attribute via the lock_broker object for the thread, and to instantiate a locked_data object via a lock_assigner object.

Lock_broker 210 object class is an encapsulation of the thread's list of shared resources. Lock_broker object class 210 is a private class that cannot be instantiated or directly used by the programmer. It is a thread singleton, which is to say there can be no more than one instances of the object class for any given thread. It is used by the framework of the present embodiment to automate acquisition of multiple mutex locks. A static instance method returns the single object instance of the class for the calling thread. The implementation of this thread singleton only differs from a traditional singleton in that an instance_attribute uses thread local storage rather than static storage as a pointer to the single instance of the lock_broker object for that thread. Its attributes are a lock_created_flag attribute and a thread_mutexes_collection attribute. The lock_created flag attribute is set the first time a lock is acquired for any shared_data object registered with the lock_broker object. After the lock_created_flag attribute is set, no further registration of shared_data objects created in other threads is allowed; this is because of implementation rule number two. The thread_mutexes_collection attribute is implemented as a mapping where each mutex address registered with the lock_broker object is a search key that maps to a mutex_recursive_wrapper object.

A create_register_data method is a special version of a register_data method that is called only by a constructor of the shared_data object. The create_register_data method ignores the lock_created_flag attribute; it only checks the lock_count_attribute value for the first mutex_recursive_wrapper object in thread_mutexes_. If the lock_count_attribute value is not zero, the method throws an exception. The register_data method checks the lock_created_flag attribute. If the flag is set, the method throws an exception. The register_data method then registers the shared_data object with the lock_broker object by adding the address of the mutex_attribute of the shared_data object to the thread_mutexes_collection attribute. An unregister_data method unregisters a shared_data object from the lock_broker object by removing its mutex address from thread_mutexes_. A get_lock method acquires a lock on the mutex for the specified shared_data object. Before acquiring a lock on the requested shared_data object, the get_lock method acquires locks on all mutexes for shared_data objects in thread_mutexes_with mutex addresses (i.e., identifiers) having a lower logical ordering. Each lock is acquired through the mutex_recursive_wrapper object via a scoped_lock 260 object.

The primary roll of lock_assigner object class 230 is to restrict the programmer's access to scoped_lock objects returned by the lock method of shared_data object class 220. All lock_assigner objects are non-copyable. By wrapping scoped_lock objects in lock_assigner object class 230, whose constructor is private, the programmer is prevented from getting at scoped_lock objects created by the lock method of shared_data object class 220. Besides a scoped locks_attribute, which is a collection of scoped_lock objects, there is also a data_attribute, which is a reference to the data encapsulated in the shared_data object. By encapsulating these two attributes in a class that has only a private constructor, the data and locks on that data cannot be directly accessed while it is being passed from the shared_data object to the locked_data object.

Locked_data object class 240 is an encapsulation of the data and locks acquired on that data that prevent race conditions. All locked_data objects are non-copyable. Its attributes are a data attribute, which is a reference to the data attribute of the shared_data object and the scoped_locks_collection attribute of the scoped_lock objects passed to it through its constructor from the lock_assigner object. It persists the scoped_lock objects for its lifetime until its destructor is called. Access to its data_attribute during its lifetime is through a get method.

Mutex_recursive_wrapper object class 250 is a thin wrapper around a regular mutex. The main difference between mutex_recursive_wrapper object class 250 and a recursive mutex is that mutex_recursive_wrapper object class 250 exposes its lock count. Exposure of the lock count allows for the relaxing of implementation rule number three for this embodiment. Aside from a lockcount_attribute, the mutex_recursive_wrapper object also has a mutex_attribute and a lock attribute. The mutex_attribute is a reference to the mutex of the shared_data object that it wraps. The lock_attribute holds a reference to a lock reference only if a lock is currently acquired on the mutex_attribute. The main constructor of mutex_recursive_wrapper object class 250 sets the mutex_attribute reference and initializes the lock_count_attribute value to zero. If the lock_attribute does not hold a reference, the lock method acquires a lock on the mutex_attribute and sets lock count to one. If the lock_attribute does hold a reference, the lock method increments the lock_count_attribute value by one. If the lock_count_attribute value is greater than one, the unlock method decrements the lock_count_attribute value by one. If the lock count attribute value is one, an unlock method sets the lock_count_attribute value to zero and releases the lock reference held by the lock_attribute.

Scoped_lock object class 260 is a thin wrapper around a regular mutex lock. This embodiment of the present invention uses a scoped lock, which automatically unlocks the mutex it was acquired on in its destructor. However, alternate embodiments may not use scoped locks. In the present embodiment, all scoped_lock objects are non-copyable. Scoped_lock object class 260 is designed to work with mutex_recursive_wrapper object class 250, and this distinguishes scoped_lock object class 260 in the present embodiment from other scoped lock implementations. In the present embodiment, the constructor takes a reference to the mutex_recursive_wrapper object that the scoped_lock object is acquired on, which it holds in its mutex_attribute. The constructor then calls the lock method of mutex_recursive_wrapper object 250 on the mutex_attribute. In its destructor, scoped_lock object 260 calls the unlock method of mutex_recursive_wrapper object 250 on the mutex_attribute. The matched calls to lock and unlock account for keeping the lock count attribute value of mutex_recursive_wrapper object 250 synchronized and non-zero as long as there are active references to the data_attribute of shared_data object 220 via the existence of locked_data objects.

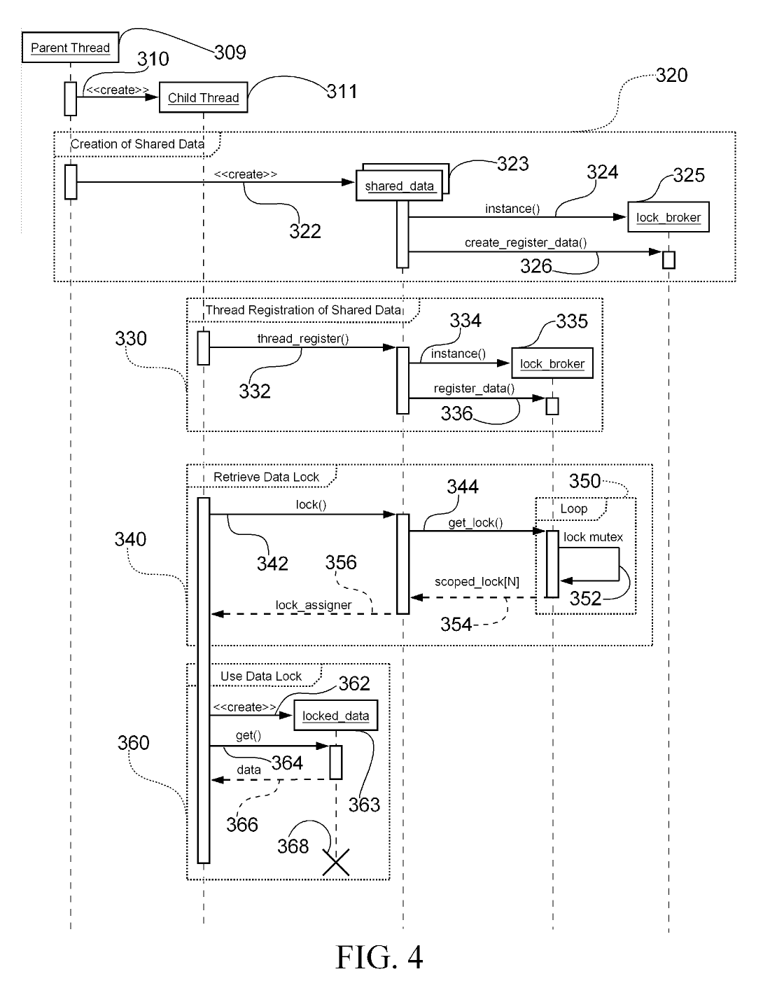

FIG. 4 is a UML sequence diagram illustrating a scenario for an exemplary method of locking shared resources with multiple threads using object oriented programming, in accordance with an embodiment of the present invention. There are four main steps in a typical use of the present embodiment. These steps, along with sub-steps are outlined in the UML sequence diagram in FIG. 4. Before the first main step, a Parent Thread 309 creates a Child Thread 311 in a create sub-step 310. Then, the first main step may occur, which is a Creation of Shared Data step 320. In Creation of Shared Data step 320, Parent Thread 309 creates a shared_data object 323 in a create sub-step 322. In the constructor of shared_data object 323, shared_data object 323 retrieves the instance of a lock_broker object 325 in Parent Thread 309 in an instance sub-step 324. The call of the instance in sub-step 324 creates lock_broker object 325 for Parent Thread 309 since the single instance for Parent Thread 309 did not previously exist. The constructor of shared_data object 323 then calls a create_register_data method on lock_broker object 325 in sub-step 326. The create_register_data method adds the mutex of shared_data object 323 to a thread_mutexes_collection of shared_data objects registered with the thread, which will then contain exactly one entry. The entry is created by wrapping the mutex in a mutex_recursive_wrapper object. The entry is keyed off of the mutex's memory address, which serves as a unique identifier for that purpose.

A Thread Registration of Shared Data step 330, which happens once for every child thread, is the next main step. In step 330 a thread_register method is called on shared_data object 323 in Child Thread 311 in sub-step 332. In the thread_register method, shared_data object 323 retrieves Child Thread's 311 instance of another lock_broker object 335 in sub-step 334. The instance call in sub-step 334 creates lock_broker object 335 for Child Thread 311 since the single instance for Child Thread 311 did not previously exist. The thread_register method then calls a register_data method on lock_broker object 335 in sub-step 336. The register_data method adds the mutex of shared_data object 323 to its thread_mutexes_container of shared_data objects registered with the thread, which will then contain exactly one entry. The entry is created by wrapping the mutex in a mutex_recursive_wrapper object which is keyed off of the mutex's memory address.

A Retrieve Data Lock step 340 may be performed any number of times in either Parent Thread 309 or Child Thread 311 after registration of all shared_data objects is complete. In this example a lock method is called on shared_data object 323 in Child Thread 311 in sub-step 342. The lock method then calls a get_lock method on lock_broker object 335 object in sub-step 344. The get_lock method begins a Loop sub-step 350.

In Loop sub-step 350, the get_lock method of lock_broker object 335 iterates through its thread_mutexes_collection beginning with the lowest key that is a mutex memory address. For each entry in the thread_mutexes_collection, the get_lock method performs a lock mutex step 352. The lock mutex step 352 creates a scoped_lock object using the mutex_recursive_wrapper for the entry in the thread_mutex_collection. Each scoped_lock object is stored in a temporary collection. The lock mutex step 352 continues until the entry is reach that has a key value matching the memory address of the mutex for shared_data object 323 being locked. A scoped_lock object is created for that entry also and added to the temporary collection with size N, where N is the number of scoped_locks created and added to the collection. In this simplified scenario there is only a single shared_data object so there is only a single entry in the thread_mutexes_collection of lock_broker object 335. However, in most cases there will be multiple shared_data objects so there would be multiple entries in the thread_mutexes_collection of the lock_broker object.

The temporary collection of scoped locks is then returned in sub-step 354 to shared_data object 323 that is making the get_lock request in sub-step 344. The lock method of shared_data object 323 then creates a lock_assigner object using the collection of scoped_lock objects returned from lock_broker object 335 in sub-step 354 and its own data_attribute. The lock_assigner object is then returned in sub-step 356 to Child Thread 311, which begins a Use Data Lock step 360.

In Use Data Lock step 360, Child Thread 311 creates a locked_data object 363 in sub-step 362 using the lock_assigner object returned in sub-step 356 from Retrieve Data Lock step 340. To access the data that locked_data object 363 is storing scoped_locks for, the get method of locked_data object 363 is called in sub-step 364. The get method returns the data_attribute of locked_data object 363 in sub-step 366, which is a reference to the data_attribute of shared_data object 323. The data returned in sub-step 366 may be used for as long as locked_data object 363 exists within the scope of the current thread's function block, represented by a continuation beginning with step 340 and completing with step 360. The destructor of locked_data object 363 is called in sub-step 368 when locked_data object 363 goes out of scope at the end of the method or function in Child Thread 311 that created it. When the destructor is called in sub-step 368, it releases all scoped_lock objects in the scoped_locks_collection of locked_data object 363. Each scoped_lock object that is released results in a mutex_recursive_wrapper object's lock_count_being reduced. When the mutex_recursive_wrapper object's lock_count_zero and the lock is released on the underlying mutex, the related shared_data can be locked in another thread.

Implementation rule number three has been greatly relaxed in this embodiment to allow creation of shared resources in a thread when no shared resources are currently locked in that thread. The remaining limitation is that shared resources may not be created in a thread when other shared resources in that thread are locked. Although an improvement over a very basic embodiment, this is still a significant limitation that very much impacts the design of a program. With this limitation the programmer is prevented from creating a new shared_data object in one method that is called by another method that has one or more locked_data objects in existence. The result is that method is not automatically composable. To get the program to work, the programmer may need to move the creation of some shared_data objects to another method and pass them as parameters. This sort of constant refactoring when composing methods or modules is undesirable.

In yet another embodiment of the present invention the limitation of implementation rule number three may be done away with completely. This embodiment is a variation on the previous embodiment where a new strategy is employed for generating unique identifiers to associate with each shared_data object. The new strategy is to ensure that the strict total ordering for unique identifiers is strictly increasing over time as unique identifiers are generated. This means that each newly generated identifier has a higher logical ordering than every identifier that was generated before it. The purpose of this strategy is to ensure that each new shared_data object always has a higher logical sort order than previously existing shared_data objects and therefore a higher locking order. The result of this strategy is that every single newly created shared_data object's lock order is always higher than the lock order of shared_data objects that previously existed, including, but not limited to, those that are already locked. This allows for shared_data objects to be created in a thread when there are shared_data objects currently locked in that thread. Using this strategy is safe since any new shared_data object would not have a lock order previous to any existing shared_data object. If a newly created shared_data object is locked immediately after creation, it will only be locked after locking all other shared_objects in the thread, and therefore the lock order is always the same as if it had been passed into the thread from another thread and registered, which avoids possible deadlock.

This flexibility gives the programmer an advantage over previous embodiments of the present invention. With this embodiment the programmer is now at liberty to combine functions, methods, or different modules within the same thread without any need to be concerned for where shared_object creation takes place. As a result of this complete composability, the programmer's time and effort can be spent solving the design problems related to the domain without getting bogged down in the multi-threading details.

The present embodiment employs a global counter to get strictly increasing identifiers that are unique. The counter starts at one and increments every time a new identifier is requested. The global counter is implemented using the traditional class singleton pattern since identifiers only need to be globally unique within the operating system process.

The global counter is implemented as an id_generator object class. The id_generator object class has an id_attribute, which is initialized to a value of zero for the class's single instance. The id_attribute's data type must be of sufficiently large data width to provide an arbitrarily large magnitude of identifier values. It is important to do this to provide stable operation of the present embodiment for a system process that may stay running for months or even years and generate more than hundreds of billions of identifiers for new shared_data objects during that time. The global counter class also has a single public method called new_id, which generates a new identifier for a shared_data object. When the new_id method is called it acquires a lock on a local mutex to prevent race conditions and increments the id_attribute. It then gets the value of the id_attribute and releases the lock acquired on the local mutex. The value of the id_attribute retrieved in the previous step is then returned. Those skilled in the art, in light of the present teachings, will readily recognize that variations of the global counter may be employed in alternate embodiments.

In this embodiment the id_generator object class is used based on the previous embodiment as follows. The identifier for a shared_data object is retrieved during its creation. In a create_register_data method of a lock_broker object class the instance of the id_generator is retrieved and the new_id method is called to retrieve the new identifier. The identifier is used as the key in a thread_mutexes_collection of the lock_broker object class when creating a mutex_recursive_wrapper. The identifier is then returned to the shared_data object and used to initialize its id_attribute. The shared_data object's id_attribute is then used in future calls to a register_data method, an unregister_data method, and a get_lock method of the lock broker object class.

A C++ reference implementation for this embodiment is supplied as a computer program listing appendix as stated in the Statements and References section. The id_generator object class as well as this embodiment's version of each object class shown in FIG. 3 is implemented in separate files of the same name as listed in that appendix. Each file has a .txt extension as required for computer program listing appendix, though they are C++ header and implementation combined in the same file. The only additional file is an auto_vector object class implementation file. The auto_vector is an additional object class used as a container of scoped_lock objects which are returned by the lock broker object class' get_lock method. Scoped_locks_attributes of a lock_assigner object class and a locked_data object class are also implemented using the auto_vector class. The reason for using the auto_vector class over a traditional vector or other standard container is that the scoped_lock objects it stores are non-copyable, which prevents the use of any C++ standard containers, as they require that the objects are copyable.

In an exemplary implementation, a sample source code snippet that demonstrates how to use the reference implementation is included at the bottom of the implementation file for the shared_data object class in a shared_data.txt file. The shared_data.txt file is the only one that needs to be included by a C++ implementation file to utilize the reference implementation. All files for the reference implementation should have their extensions changed from .txt to .hpp before attempting to compile them. All other dependent reference implementation files are included by the shared_data.txt file and assumed to be in the same folder. The reference implementation utilizes mutex and lock object classes from the Boost C++ thread library version 1.34.1. Therefore this library must be installed to be able to compile the reference implementation. The Boost C++ libraries may be downloaded from www.boost.org.

One drawback of this embodiment compared to previous embodiments of the present invention is that it results in a slight performance hit due to additional locking of the local mutex in id_generator's new id method. This additional locking happens just once per creation of a shared_data object, and not while locking a shared_data object. Therefore the worst performance case is when shared_data objects are created in a loop and locked just once. Specifically, this results in a performance hit of 2N where N is the amount of time to acquire a single lock on a single mutex. Thus this embodiment has at least half the locking performance of previous embodiments. However, on average the performance will be much better.

In yet another alternate embodiment, which is a variation of the previous embodiment, the id_generator global counter is dispensed with. To replace its function a process is put in place where newly created shared_data objects are registered at the end of a lock_broker's list for the thread in which the shared_data object was created. In this embodiment the order in which the shared_data objects are registered establishes the order in which they occur in the thread_broker's list, and hence the order in which mutex locks are acquired. The order in the thread_broker's list is the total ordering. Consequently shared_data objects may only be shared with child threads. Any subset of shared_data objects registered with a thread's thread_broker may be shared with a child thread. The order of registration of shared_data objects in the child thread is determined by the order the shared_data objects were registered in the parent thread's own thread_broker list at the time of sharing. This ensures that shared_data objects are always registered in a consistent order with all child threads.

Additional shared_data objects may be shared with child threads after the initial creation of the child thread, but only if the shared_data object is created after the initial creation of the child thread. Allowing additional sharing of new shared_data objects after the initial creation of the child thread requires the parent thread to track the last shared_data object in its list shared with each child thread. A request to share a shared_data object with a child thread of a lower order than had already been shared with the child thread needs to generate an exception to generally prevent shared_data objects from being registered in a different order with the child thread than they were registered in the parent thread.

The present invention in its various embodiments has many advantages over previous solutions. In its latter embodiments the present invention has strong protection against accidental race conditions. It avoids deadlock without any special consideration on the part of the programmer for lock classification or lock placement within a method. It is generally composable, which results in real savings in increased productivity since functions, methods and modules can be combined, divided and refactored without any necessary caution on the part of the programmer. This kind of careless refactoring is possible since the avoidance of deadlock always holds, even when holding a lock and calling unknown code, as long as the unknown code also utilizes the present invention for any resources shared with the unknown code. Finally, the present invention does not lend itself to starvation, and by establishing the correct preconditions, starvation will generally not result through the process of acquiring shared resources.

While the foregoing embodiments were designed specifically for the purpose of preventing deadlock among multiple threads in the same operating system process, those skilled in the art will readily recognize that the same approach used in the forgoing embodiments may be readily adapted to multiple operating system processes to prevent deadlock between multiple processes on the same operating system.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

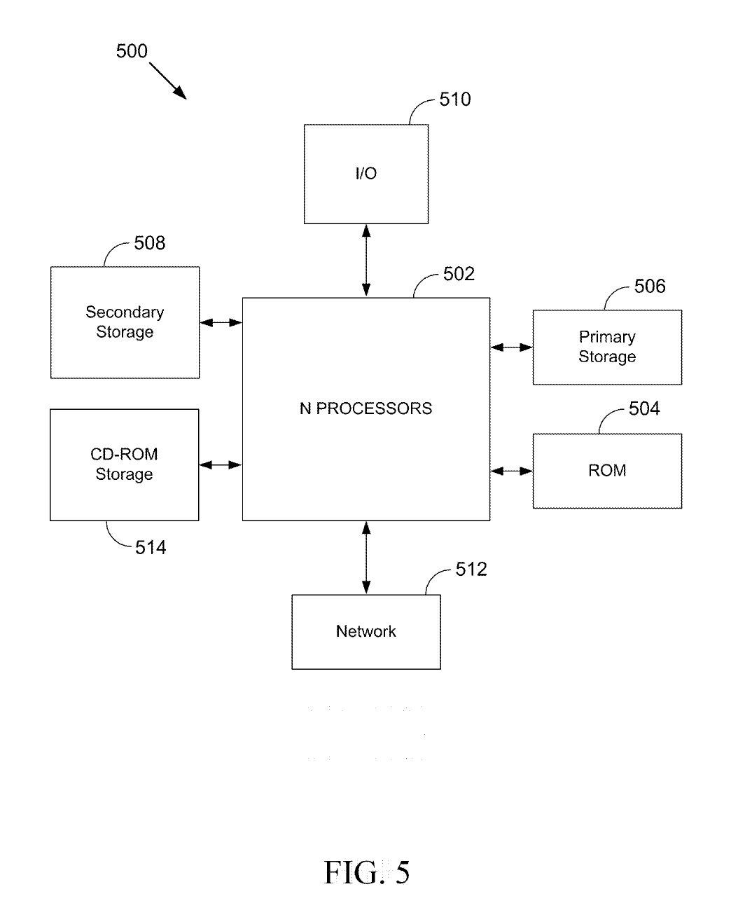

FIG. 5 illustrates a typical computer system that, when appropriately configured or designed, can serve as a computer system in which the invention may be embodied. The computer system 500 includes any number of processors 502 (also referred to as central processing units, or CPUs) that are coupled to storage devices including primary storage 506 (typically a random access memory, or RAM), primary storage 504 (typically a read only memory, or ROM). CPU 502 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 504 acts to transfer data and instructions uni-directionally to the CPU and primary storage 506 is used typically to transfer data and instructions in a bi-directional manner. Both of these primary storage devices may include any suitable computer-readable media such as those described above. A mass storage device 508 may also be coupled bi-directionally to CPU 502 and provides additional data storage capacity and may include any of the computer-readable media described above. Mass storage device 508 may be used to store programs, data and the like and is typically a secondary storage medium such as a hard disk. It will be appreciated that the information retained within the mass storage device 508, may, in appropriate cases, be incorporated in standard fashion as part of primary storage 506 as virtual memory. A specific mass storage device such as a CD-ROM 514 may also pass data uni-directionally to the CPU.

CPU 502 may also be coupled to an interface 510 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 502 optionally may be coupled to an external device such as a database or a computer or telecommunications or internet network using an external connection as shown generally at 512, which may be implemented as a hardwired or wireless communications link using suitable conventional technologies. With such a connection, it is contemplated that the CPU might receive information from the network, or might output information to the network in the course of performing the method steps described in the teachings of the present invention.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing novel means for and/or steps described that the applications designer will selectively decide, depending upon the practical considerations of the particular implementation, to carry out and/or locate within the jurisdiction of the USA. For any claims construction of the following claims that are construed under 35 USC §112 (6) it is intended that the corresponding means for and/or steps for carrying out the claimed function also include those embodiments, and equivalents, as contemplated above that implement at least some novel aspects and objects of the present invention in the jurisdiction of the USA.

Having fully described at least one embodiment of the present invention, other equivalent or alternative methods of generally preventing deadlock in multi-threaded programs according to the present invention will be apparent to those skilled in the art. The invention has been described above by way of illustration and reduction to practice, and the specific embodiments disclosed are not intended to limit the invention to the particular forms disclosed. The invention is thus to cover all modifications, equivalents, and alternatives falling within the spirit and scope of the following claims.

Claim elements and steps herein have been numbered and/or lettered solely as an aid in readability and understanding. As such, the numbering and lettering in itself is not intended to and should not be taken to indicate the ordering of elements and/or steps in the claims.

What is claimed is:

1. A system for programming a concurrent software application, the system comprising:
a plurality of shared resources;
means for maintaining a strict total ordering of said shared resources;
means for enabling a thread to acquire exclusive access to said shared resources; and
means for maintaining a list of locks acquired during access of a shared resource by said thread, wherein each of said locks has been acquired in an order corresponding to said strict total ordering of said shared resources.

2. The system as recited in claim 1, wherein each of said enabling means enables said thread to acquire said exclusive access a plurality of times.

3. The system as recited in claim 1, wherein said shared resources and said lock list are encapsulated as object classes.

4. The system as recited in claim 1, further comprising means for generating a unique identifier for each of said shared resources that is increasing.

5. A method for programming a concurrent software application, the method comprising:
steps for registering a shared resource for a thread of the application, where said shared resource is uniquely identified;
steps for requesting a lock on said shared resource for exclusive access to said shared resource by said thread;
steps for identifying all shared resources to be locked with said shared resource;
steps for acquiring locks on said identified shared resources and said shared resource;
steps for assigning a lock list of acquired locks to said shared resource;
steps for performing an operation on said shared resource;
steps for releasing said acquired locks upon completion of said operation;
steps for repeating said steps for requesting, identifying, acquiring, assigning, performing and releasing until said thread has completed performing operations on said shared resource; and
steps for unregistering said shared resource.

6. The method as recited in claim 5, further comprising steps for creating a shared resource for a thread of the application.

7. The method as recited in claim 5, further comprising steps for aborting said thread upon determination that registering said shared resource results in an inconsistent ordering.

8. The method as recited in claim 5, further comprising steps for aborting said thread upon determination of a failure of registering said shared resource.

9. The method as recited in claim 5, further comprising steps for encapsulating said shared resource and said lock list as object classes.

10. The method as recited in claim 5, further comprising steps for generating unique identifiers associated with said shared resources that is increasing.

11. A system for programming a concurrent software application, the system comprising:
a plurality of shared resources;
an ordered list of said shared resources used by each thread of the application for maintaining a strict total ordering of said shared resources, where each of said shared resources includes a unique identifier;
a plurality of mutexes, each of said mutexes being associated with a one of said shared resources for enabling a thread to acquire exclusive access to said associated one of said shared resources; and
a mutex lock list associated with a shared resource for maintaining a list of mutex locks acquired during access of said shared resource by said thread, said list comprised of said mutex associated with said shared resource and all mutexes of shared resources preceding said shared resource in said ordered list, wherein each of said mutex locks has been acquired in an order corresponding to said strict total ordering of said shared resources.

12. The system as recited in claim 11, wherein each of said mutexes enables said thread to acquire said exclusive access a plurality of times.

13. The system as recited in claim 11, wherein said mutex locks are released after said access.

14. The system as recited in claim 11, wherein said mutex lock list is populated prior to said access.

15. The system as recited in claim 11, wherein said shared resources and said mutex lock list are encapsulated as object classes.

16. The system as recited in claim 11, wherein said unique identifier is generated to be strictly increasing.

17. A method for programming a concurrent software application, the method comprising steps of:
registering a shared resource for a thread of the application, where said shared resource is uniquely identified in an ordered list of shared resources;
requesting a lock on said shared resource for exclusive access to said shared resource by said thread;
identifying all shared resources in said ordered list, ordered before said shared resource, to be locked with said shared resource;
acquiring locks on mutexes associated with said identified shared resources and said shared resource in an order of placement in said ordered list;
assigning a mutex lock list of acquired mutex locks to said shared resource;
performing an operation on said shared resource;
releasing said acquired mutex locks upon completion of said operation;
repeating said steps of requesting, identifying, acquiring, assigning, performing and releasing until said thread has completed performing operations on said shared resource; and
unregistering said shared resource upon completion of operations on said shared resource by said thread.

18. The method as recited in claim 17, further comprising the step of creating a shared resource for a thread of the application.

19. The method as recited in claim 17, wherein the step of unregistering further comprises removing said shared resource from said ordered list.

20. The method as recited in claim 17, further comprising the step of aborting said thread upon determination that registering said shared resource results in an inconsistent ordering of shared resources among threads in the application.

21. The method as recited in claim 17, further comprising the step of aborting said thread upon determination that said shared resource, for which a lock has been requested, is absent from said ordered list.

22. The method as recited in claim 17, further comprising the step of encapsulating said shared resource and said mutex lock list as object classes.

23. The method as recited in claim 18, further comprising the step of generating unique identifiers associated with said shared resources where said created shared resource has a higher logical ordering unique identifier than previously registered shared resources.

24. A computer program product for programming a concurrent software application, the computer program product comprising:
computer program code for registering a shared resource for a thread of the application, where said shared resource is uniquely identified in an ordered list of shared resources;
computer program code for requesting a lock on said shared resource for exclusive access to said shared resource by said thread;
computer program code for identifying all shared resources in said ordered list, ordered before said shared resource, to be locked with said shared resource;
computer program code for acquiring locks on mutexes associated with said identified shared resources and said shared resource in an order of placement in said ordered list;
computer program code for assigning a mutex lock list of acquired mutex locks to said shared resource;
computer program code for performing an operation on said shared resource;
computer program code for releasing said acquired mutex locks upon completion of said operation;
computer program code for repeating said steps of requesting, identifying, acquiring, assigning, performing and releasing until said thread has completed performing operations on said shared resource;
computer program code for unregistering said shared resource upon completion of operations on said shared resource by said thread; and
a computer-readable media that stores the computer program code.

25. The computer program product as recited in claim 24, further comprising computer program code for creating a shared resource for a thread of the application.

26. The computer program product as recited in claim 24, wherein said computer program code for unregistering further comprises computer program code for removing said shared resource from said ordered list.

27. The computer program product as recited in claim 24, further comprising computer program code for aborting said thread upon determination that registering said shared resource results in an inconsistent ordering of shared resources among threads in the application.

28. The computer program product as recited in claim 24, further comprising computer program code for aborting said thread upon determination that said shared resource, for which a lock has been requested, is absent from said ordered list.

29. The computer program product as recited in claim 24, further comprising computer program code for encapsulating said shared resource and said mutex lock list as object classes.

30. The computer program product as recited in claim 25, further comprising computer program code for generating unique identifiers associated with said shared resources where said created shared resource has a higher logical ordering unique identifier than previously registered shared resources.
